(19) United States
(12) Patent Application Publication
(10) Pub. No.: US 2007/0108761 A1
(43) Pub. Date: May 17, 2007

(54) Quick pipe connector

(76) Inventors: Hao-Chih Ko, Taipei County (TW); Chen-Heng Lin, Taipei (TW)

Correspondence Address: BACON & THOMAS, PLLC, 625 SLATERS LANE, FOURTH FLOOR, ALEXANDRIA, VA, 22314, US

(21) Appl. No.: 11/274,404

(22) Filed: Nov. 16, 2005

(51) Int. Cl. F16L 39/00

(52) U.S. Cl. 285/317

(57) ABSTRACT

A quick pipe connector includes a connector body, a separating section fixed onto an internal wall between both ends of the connector body, a piston section movable coupled in the separating section, and a first connecting section and a second connecting section disposed on both ends of the connector body respectively. The first connecting section and the connector body are interconnected, so that liquid can pass through the connector body. If the piston section is moved towards the first connecting section, then the separating section is interconnected. If the piston section is moved towards the second connecting section, then the separating section is shut to prevent liquid from flowing out continuously.

### FIELD OF THE INVENTION

The present invention relates to a pipe connector, and more particularly to a pipe connector that can be installed securely and quickly.

### BACKGROUND OF THE INVENTION

There are many ways of connecting a pipeline traditionally, and different connecting methods are adopted for different requirements. A general way of connecting a pipeline is to use the principle of thermal expansion and contraction by warming a pipe connector with fire, such that the connecting section of a pipe can be softened by a high temperature, and the expanded connecting section is inserted into another pipe wrapped with a leakage-resistant tape in a quick and secured fashion. The pipe can be fixed after the pipe is cooled. However, such method still has the following shortcomings. It requires skillful installation personnel to control the fire for the warming, or else the connecting section will be melted or cannot be inserted. Furthermore, if a pipeline is inserted improperly or it is necessary to replace the old pipeline, then it is necessary to cut the old pipeline and reinstall a new pipe or connector. Such arrangement not only wastes materials, but also delays construction time.

Since the connection of the foregoing pipeline does not require skillful technicians for the installation or warming by fire during the construction that results a long construction time, a high risk, and a high material cost, therefore some manufacturers have developed a quick connector as disclosed in R.O.C. Pat. No. M255,362 entitled “Improved structure of a quick water pipe connector”. Referring to FIGS. 1 and 2 for such quick water pipe connector, the quick water pipe connector comprises a rotary lid 10, a reinforcing ring 11, an engaging plate 12, and a water pipe connector 13, wherein the rotary lid 10 is an n-shaped hollow body having a screw thread on an internal side connected to another thread 130 at one end of the water pipe connector 13. The reinforced ring 11 is a ring body having a blocking wall 110 with a slanting protrusion, and the engaging plate 12 is an elastic ring body and having a plurality of splinters 120 in an agnail shape. The pipe connector 13 is a hollow body and another screw thread 130 can be secured to the screw thread on the rotary lid 10, and the splinters 120 on the engaging plate 12 are embedded into the pipe, and the blocking wall of the reinforced ring 11 also blocks the splinters 120 from being separated or deformed, so as to achieve the effect of securing the pipe and preventing the pipe from being pulled out.

If it is necessary to install the pipe, the pipe is inserted into the pipe connector 13 from the rotary lid 10 and then pulled back slightly, such that the splinter 120 of the engaging plate 12 is embedded into the pipe, and the blocking wall of the reinforced wall 11 also blocks the splinters 120 from being fallen out or deformed, so as to achieve the effect of securing the pipe and preventing the pipe from being pulled out. If it is necessary to change the pipe, the rotary lid 10 is turned to pull out the pipe, and then the rotary lid 10 is turned to reinstall a new water pipe into the pipe connector 13 and pull the water pipe back slightly to complete the replacement of pipes. Such arrangement does not require special skills and general users can install or replace the pipe by themselves.

However, the prior art quick pipe connector still has the existing shortcomings. When the pipe connector 13 is removed, the master switch of the pipeline must be shut first, otherwise a large quantity of water will be sprayed out when the pipe connector 13 is removed. However, it is generally not easy to find the location of the master switch of the related pipeline, and thus causing a delay of the construction. Further, when the pipe connector 13 is separated from the pipe, the water in the water pipe at the position close to the opening of the pipe still leaks out even though the master switch of the related pipeline is shut, and thus causing a mess and a poor quality of the construction. Therefore, finding a way of improving the foregoing shortcomings becomes an important issue.

### SUMMARY OF THE INVENTION

In view of the foregoing shortcomings of the prior art quick pipe connector, the inventor of the present invention based on years of experience to conduct extensive researches and experiments to improve the prior art, and finally invented an improved quick pipe connector in accordance with the present invention.

Therefore, it is a primary objective of the present invention to provide a quick pipe connector comprising a connector body, a separating section fixed onto an internal wall between both ends of the connector body, a piston section movably coupled in the separating section, and a first connecting section and a second connecting section disposed on both ends of the connector body respectively, and the first connecting section and the connector body are interconnected, so that liquid can pass through the connector body. If the piston section is moved towards the first connecting section, then the separating section is interconnected. If the piston section is moved towards the second connecting section, then the separating section is shut to prevent liquid from flowing out continuously.

The above and other objects, features and advantages of the present invention will become apparent from the following detailed description taken with the accompanying drawings.

### BRIEF DESCRIPTION OF THE DRAWINGS

FIG. 1 is an exploded view of a prior art quick pipe connector;

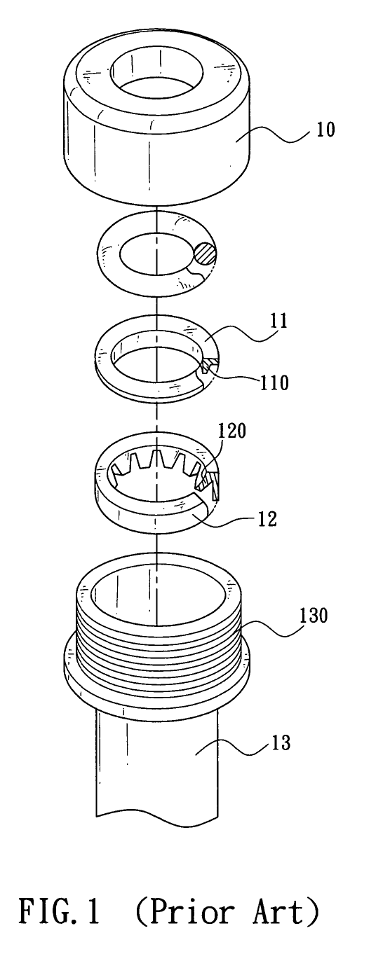

FIG. 2 is a cross-sectional view of a prior art quick pipe connector;

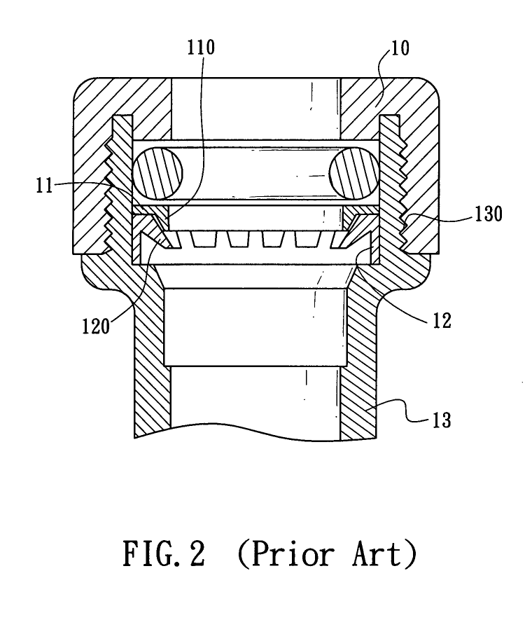

FIG. 3 is an exploded view of a quick pipe connector of the invention;

FIG. 4 is a cross-sectional view of a quick pipe connector of the invention;

FIG. 5 is a schematic view of a separating section of the invention;

FIG. 6 is a perspective view of quick pipe connectors being connected with each other according to the invention; and

FIG. 7 is an exploded view of quick pipe connectors being connected with each other according to the invention.

### DETAILED DESCRIPTION OF THE PREFERRED EMBODIMENTS

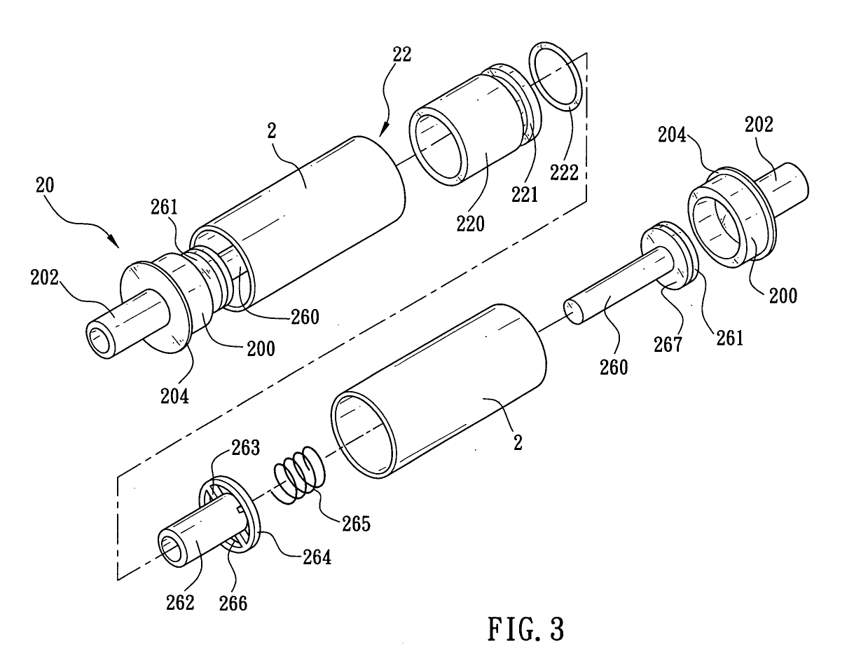

Referring to FIGS. 3 to 5 for the quick pipe connector in accordance with the present invention, the quick pipe connector comprises a connector body 2, and the connector body 2 comprises a first connecting section 20, a second connecting section 22, a separating section 24, and a piston section 26, wherein the first connecting section 20 is installed at an end of the connector body 2 and interconnected with the connector body 2, and the second connecting section 22 is installed at another end of the connector body 2 and interconnected with the connector body 2, and the separating section 24 is fixed between both ends of the connector body 2 for liquid flowing into the connector body 2 to flow towards another end of the connector body 2, and the piston section 26 is movably disposed in the separating section 24. If the piston section is moved towards the first connecting section 20, the separating section 24 will be in an interconnected status, such that the liquid can pass through the separating section 24 and flow towards another end of the connector body 2. If the piston section 26 is moved towards the second connecting section 22, the separating section 24 will be in a closed status, such that the liquids cannot pass through the separating section 24 to flow towards another end of the connector body 2. Such arrangement can connect a pipeline quickly and prevent the liquid from flowing out continuously.

Referring to FIG. 3 to a preferred embodiment of the present invention, the first connecting section 20 includes a cover ring 200 being coupled to an internal wall at an end of the connector body 2, and the cover ring 200 includes a connecting pipe 202 disposed on a distal surface of the connector body 2 and inserted into a pipe body, such the pipe body can be fixed onto the first connecting section 20, and the cover ring 200 includes a protrusion 204 disposed proximate to a position with its back facing an end of the periphery of the connector body 2, and the protrusion 204 presses against an end of the connector body 2, such that the first connecting section 20 is fixed onto the connector body 2 and will not be slid.

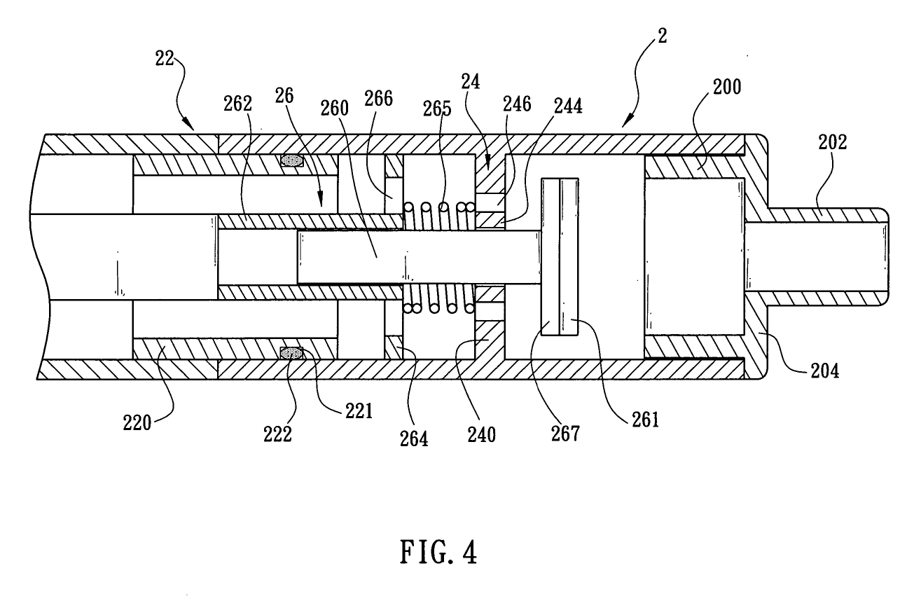

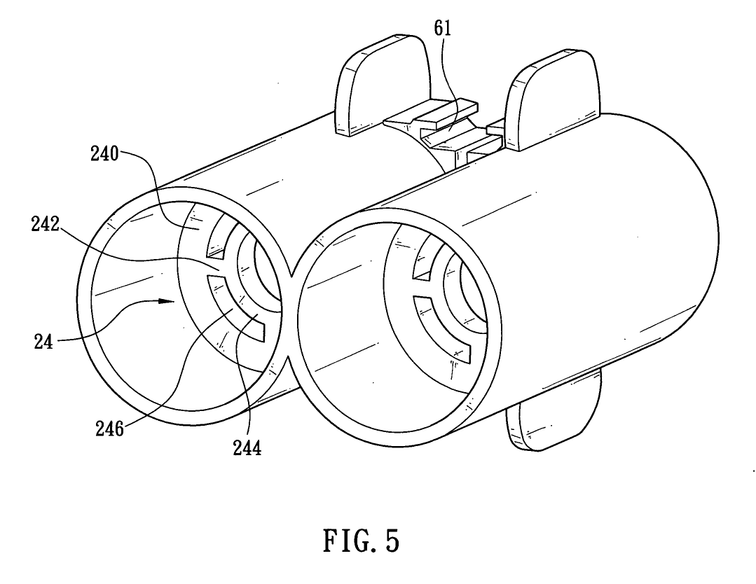

Referring to FIGS. 4 and 5 for the preferred embodiment of the present invention, the separating section 24 comprises an external ring 240, a plurality of ribs 242, and an internal ring 244, wherein said external ring 240 is fixed onto an internal wall of the connector body 2, and an end of the rib 242 is coupled to an internal wall of the external ring 240, and the other end is coupled to an external wall of the internal ring 244, and the piston section 26 is contained by the internal wall of the internal ring 244 and moved at the internal wall of the internal ring 244, and a plurality of openings 246 is formed among the external ring 240, the ribs 242, and the internal ring 244, and the openings 246 are provided for passing the liquid. If the piston section 26 is moved towards the second connecting section 22, the opening 246 will be in a closed status.

Referring to FIGS. 4 and 5 for the preferred embodiment of the present invention, the piston section 26 comprises a link rod 260, a bushing 262, and a resilient member 265, wherein the piston section 26 includes a piston 261 disposed at an end of the link rod 260 facing the connector body. If the link rod 260 is moved towards the second connecting section 22, the piston 261 will press precisely on the openings 246, and the openings 246 will be in a closed status, such that the liquid cannot pass through the openings 246. The bushing 262 is coupled to another end of the link rod 260, and an end of the bushing 262 is extended to another end of the link rod 260, and another end of the bushing 262 is extended between both ends of the link rod 260, and the resilient member 265 is coupled onto the link rod 260, and both ends of the resilient member 265 press against the position between the ribs 242 and another end of the bushing 262.

By the resilience of the resilient member 265, the link rod 260 is pushed towards another end of the connector body 2, such that the piston 261 presses onto the openings 246, so that the liquid cannot pass through. Therefore, if the quick pipe connector is installed, the liquid can be prevented from flowing out. Another connector body 2 with identical structure and shape is inserted into the second connecting section 22, and another end of the link rod 260 is pushed by another end of another connector body 2, such that the piston 261 is moved away from the openings 246, and the liquid can pass through the connector body 2.

Referring to FIG. 3 for the preferred embodiment of the present invention, another end of the bushing 262 includes another plurality of ribs 263 and another external ring 264, wherein an end of these ribs 263 is disposed on another end of the bushing 262, and another end of these ribs 263 is coupled to an internal wall of another external ring, such that another plurality of openings are formed among another end of another bushing 262, other ribs 263 and another external ring 264 for passing the liquid through the connector body 2.

Referring to FIG. 4 for the preferred embodiment of the present invention, the piston 261 includes a washer 267 disposed on a side facing the openings 246, and if the piston 261 presses against the openings 246, the washer 267 will be able to prevent the liquid from flowing out from the space between the piston 261 and the openings 246.

Referring to FIGS. 3 and 4 for the preferred embodiment of the present invention, the second connecting section 22 includes a hollow connecting bushing 220, and an end of the connecting bushing 220 is fixed in the second connecting section 22, and another end is extended out of the second connecting section 22 to a specific distance. A groove 221 is disposed at another end of the connecting bushing 220 and around the connecting bushing 220, and the groove 221 includes another washer 222, such that when the two connector bodies 2 with identical structure and shape are coupled, the connecting bushing 220 and another washer 222 can prevent the liquid from flowing out from the seam of the connector bodies 2.

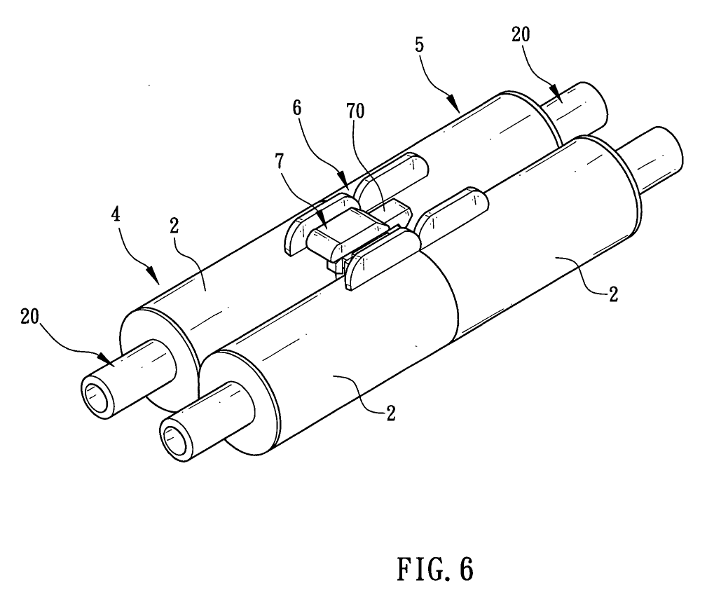

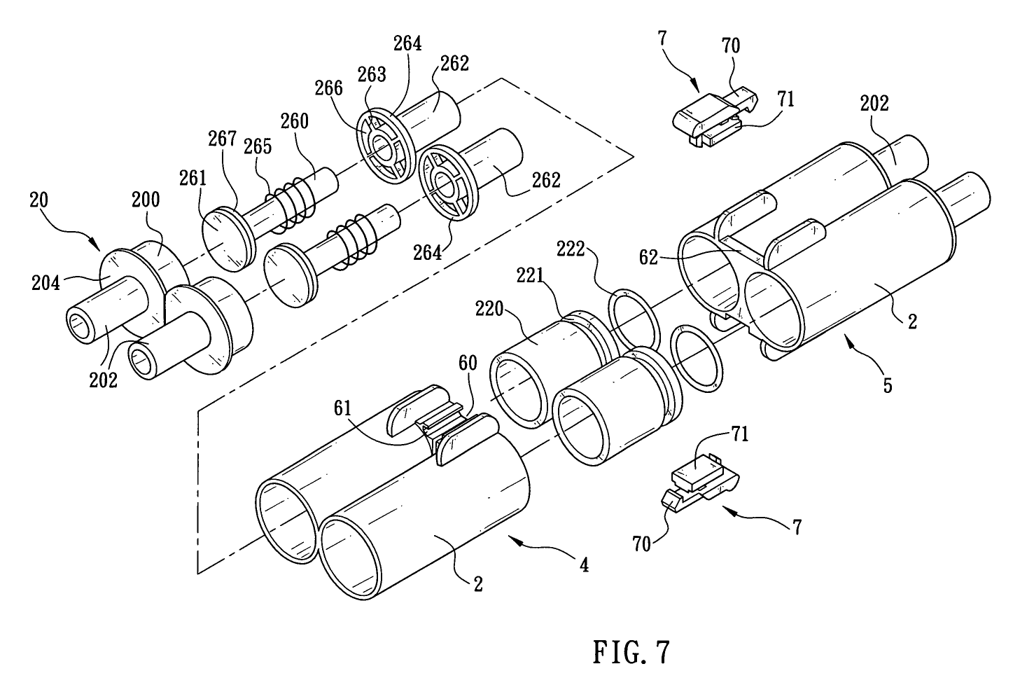

Referring to FIGS. 6 and 7 for the quick pipe connector module in accordance with the present invention, the quick pipe connector module includes a plurality of quick pipe connectors 4 and a plurality of other quick pipe connectors 5, wherein the quick pipe connectors 4 are connected adjacent to each other, and the other quick pipe connectors 5 are also connected adjacent with each other and coupled to the plurality of quick pipe connectors 4 respectively. At least one latching section 6 is disposed at the connecting position between the quick pipe connectors 4 and the other quick pipe connectors 5. An end of the latching section 6 is disposed at the quick pipe connector 4 and proximate to an end connected to the other quick pipe connector 5, and another end of the latching section 6 is disposed at another quick pipe connector 5 and proximate to an end connected to the quick pipe connector 4. The latching section 6 is connected to a latch 7, and a portion of the latch 7 is contained in one end of the latching section 6, and another portion of the latch 7 is contained in another end of the latching section 6, so as to quickly complete the connection of a large number of pipelines, and securely integrate the quick pipe connectors 4, 5 as a whole.

Referring to FIGS. 6 and 7 for the preferred embodiment of the present invention, the quick pipe connectors 4 and the other quick pipe connectors 5 have identical structure and shape, and comprises a connector body 2, and the latching section 6 is disposed at the connecting position of the connector bodies 2, and the latch 7 comprises a hook 70 and a sliding member 71, wherein the hook 70 is installed at an end of the latch 7, and the hook 70 can latch a hook member 62 disposed on another end of the latching section 6. If another end of the latch 7 approaches the connector body 2, then the hook 70 will be separated from the hook member 62, and the sliding member 7 is installed between both ends of the latch 7, and the sliding member 7 is contained in a containing groove 61 disposed at an end of the latching section 6, so as to securely integrate the quick pipe connectors 4, 5 as a whole.

While the invention herein disclosed has been described by means of specific embodiments, numerous modifications and variations could be made thereto by those skilled in the art without departing from the scope and spirit of the invention set forth in the claims.

What is claimed is:

1. A quick pipe connector quick pipe connector, comprising:
a connector body;
a first connecting section, disposed at an end of said connector body and connected with said connector body;
a second connecting section, disposed at another end of said connector body and connected with said connector body;
a separating section, fixed onto an internal wall between both ends of said connector body; and
a piston section, movably installed in said separating section and moving towards said first connecting section, and said separating section is in an interconnected status, and said piston section moves towards said second connecting section to close said separating section.

2. The quick pipe connector of claim 1, wherein said first connecting section comprises:
a cover ring, coupled onto an internal wall disposed at an end of said connector body;
a connecting pipe, disposed on said cover ring and having its back facing a distal surface of said connector body, and said connecting pipe is coupled with a pipe body; and
a protrusion, disposed around the periphery of said cover ring and having its back facing an end of said connector body, and said protrusion presses against an end of said connector body.

3. The quick pipe connector of claim 1, wherein said separating section comprises:
an external ring, fixed on an internal wall of said connector body;
an internal ring, installed in said external ring, and said piston section is contained in an internal wall of said internal ring; and
a plurality of ribs, having an end coupled to an internal wall of said external ring and the other end coupled to an external wall of said internal ring, and a plurality of openings are formed among said internal ring, said ribs, and said external ring, and said piston section moves towards said first connecting section to define an opened status of said openings, and said piston section moves towards said second connecting section to close said openings.

4. The quick pipe connector of claim 3, wherein said piston section comprises:
a link rod, including a piston disposed at an end of said link rod facing said connector body, and when said piston section moves towards said second connecting section, said piston presses against said openings;
a bushing, coupled to another end of said link rod and having an end extended to another end of said link rod, and another end of said bushing being extended between both ends of said link rod; and
a resilient member, disposed on said link rod and both ends of said resilient member pressing against a position between said ribs and another end of said bushing, such that the resilience of said resilient member is used to move said link rod towards said second connecting section, and said piston presses on said openings.

5. The quick pipe connector of claim 4, wherein another end of said bushing comprises:
another external ring, disposed at another end of said bushing; and
a plurality of other ribs, having both ends disposed between another end of said bushing and an internal wall of said other external ring; and a plurality of other openings being disposed among another end of said bushing, said plurality of other ribs, and said other external ring.

6. The quick pipe connector of claim 4, wherein said piston includes a washer disposed at a side facing said openings.

7. The quick pipe connector of claim 4, wherein said second connecting section comprises:
a connecting bushing, being hollow and having an end fixed in said second connecting section and another end being extended from said second connecting section with a predetermine distance, and a groove being disposed proximate to another end of said connecting bushing and around said connecting bushing; and
another washer, disposed on said groove.

8. A quick pipe connector module, comprising:
a plurality of quick pipe connectors, coupled and disposed adjacent with each other;
a plurality of other quick pipe connectors, coupled and disposed adjacent with each other, and coupled with said quick pipe connectors:
a latching section, disposed at a connecting position between said quick pipe connector and said other quick pipe connector, and an end of said latching section being disposed at said quick pipe connector and proximate to an end of a position connecting with said other quick pipe connector, and the other end of said latching section being disposed at said other quick pipe connector and proximate to a position connecting with said quick pipe connector; and
a latch, coupled onto said latching section and a portion of said latch being contained at an end of said latching section, and another portion of said latch being contained at another end of said latching section, and a blocking plate being disposed separately on both sides of said latching section.
